(19) United States
(12) Patent Application Publication
(10) Pub. No.: US 2008/0149691 A1
(43) Pub. Date: Jun. 26, 2008

(54) System, Valve and Method for Jetting Viscous Liquids

(75) Inventor: Hideyo Fujii, Tokyo (JP)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/814,935

(22) PCT Filed: Feb. 15, 2006
(86) PCT No.: PCT/US2006/005233

§ 371 Date: Jul. 27, 2007

Related U.S. Application Data
(60) Provisional application No. 60/653,771, filed on Feb. 17, 2005.

(51) Int. Cl. B23K 31/02; B23K 37/06

(52) U.S. Cl. 228/260; 228/33

(57) ABSTRACT

A system (10), valve and method for intermittent jetting of viscous materials, such as solder paste includes a valve (12) with a valve body having a supply passage (50). A valve stem (26) is mounted for reciprocating movement in the valve body between open and closed positions and includes a tapered end (28). A valve seat (30) is positioned adjacent the end of the valve stem (26) and includes a through passage (36) communicating with an outlet passage (40) of the valve body. The end of the valve stem (26) extends into the through passage (36) in the closed position. A positioner device (20) may carry the valve (12) and can move the valve (12) in multiple directions relative to a substrate (18) during a jetting operation. The amount of material jetted from the outlet passage (40) during a stroke of the valve stem (26) can be less than about 25% of the total combined volumes of the through passage (36) and the outlet passage (40).

### FIELD OF THE INVENTION

The present invention generally relates to liquid dispensing valves and, more particularly, valves used for intermittently jetting viscous liquids.

### BACKGROUND OF THE INVENTION

Valves with reciprocating valve elements have been used for jetting liquid materials, especially in applications requiring intermittent application of very small amounts of liquid, such as in the electronics manufacturing area. Solder paste materials used in this area have not been well suited to jetting operations because these materials tend to clog the valve after repeated operation. Specifically, the solder paste tends to become compacted within the dispensing passage thereby clogging the outlet of the valve. For this reason, screw-type valves have, for example, been better suited for the solder paste dispensing applications. Unfortunately, screw-type valves are slow and have various other drawbacks. Therefore, there is a need in the art for an improved valve capable of reliably jetting viscous liquids such as solder paste while successfully addressing problems experienced in the past.

### SUMMARY OF THE INVENTION

The present invention, in a first embodiment, generally comprises a valve for intermittent jetting of viscous materials, such as solder paste, in various applications. For example, solder paste is used in many electronic component manufacturing operations. The valves and jetting methods disclosed herein may have one or more of the various unique features disclosed herein. The valve includes a valve body having a supply passage. A valve stem or needle is mounted for reciprocating movement in the valve body between open and closed positions and includes an end that may be tapered at an included angle less than about 40 degrees. A valve seat is positioned adjacent the end of the valve stem and includes a through passage communicating with an outlet passage of the valve body. The end of the valve stem extends into the through passage in the closed position. In one aspect, the amount of material jetted from the outlet passage during a stroke of the valve stem is less than about 25% of the total combined volumes of the through passage and the outlet passage.

In another aspect of the invention, the outlet passage is of smaller diameter than the through passage. In the illustrative embodiment, the outlet passage is advantageously about one third the diameter of the through passage.

In another aspect, the outlet passage has a length approximately two thirds of the length of the through passage.

The included angle at the tapered end of the valve stem may more specifically be between about 30 degrees and about 40 degrees in the first embodiment.

In another aspect of the invention, the valve stem or needle at the widest portion of the tapered end has a diameter N_{d} and the through passage or inner seat diameter S_{d} also has a diameter. In this aspect, S_{d} is chosen to be approximately 10% to approximately 30% less than N_{d} for effective jetting of viscous materials, such as solder paste. In specific embodiments, N_{d} may be equal to or less than approximately 1.5 mm, while the difference between N_{d} and S_{d} may be approximately 0.2 mm.

A positioner device can carry the valve in a dispensing system and, preferably, can move the valve in multiple directions relative to a substrate during a jetting operation. In the illustrative embodiment, the positioner is an electromechanical x-y-z positioner or robot.

The invention further contemplates methods for intermittently jetting viscous materials using a valve as generally described herein with one or more of its disclosed features. In one aspect, the method can include an initial step of supplying the viscous material to the supply passage under pressure. The valve stem is moved to the open position such that the end of the valve stem moves from a position partially contained in the through passage to a position at least partially removed from the through passage. The through passage is filled with the viscous material, and the valve stem is moved to the closed position. This jets the viscous material from an outlet passage communicating with the through passage. The amount of material jetted from the outlet passage may be less than about 25% of the total combined volumes of the through passage and the outlet passage. More preferably, the jetted amount is about 20% of the total combined volumes of the through passage and the outlet passage. The viscous material preferably further comprises a solder paste. The method can further comprise carrying and moving the valve with a positioner device relative to a substrate onto which the material is jetted.

The features and objectives of the present invention will become more readily apparent from the following Detailed Description taken in conjunction with the accompanying drawings.

### BRIEF DESCRIPTION OF THE DRAWINGS

FIG. 1 is a schematic illustration of a dispensing system including a needle valve constructed in accordance with the invention and an x-y-z positioner device coupled to the valve.

FIG. 2 is a cross sectional view generally taken along the axis of the valve and showing the dispensing portion thereof.

FIG. 2A is an enlarged view of the encircled portion of FIG. 2.

FIG. 3 is an enlarged cross sectional view similar to FIG. 2A but illustrating another embodiment of a valve dispensing portion.

### DETAILED DESCRIPTION OF THE ILLUSTRATIVE EMBODIMENTS

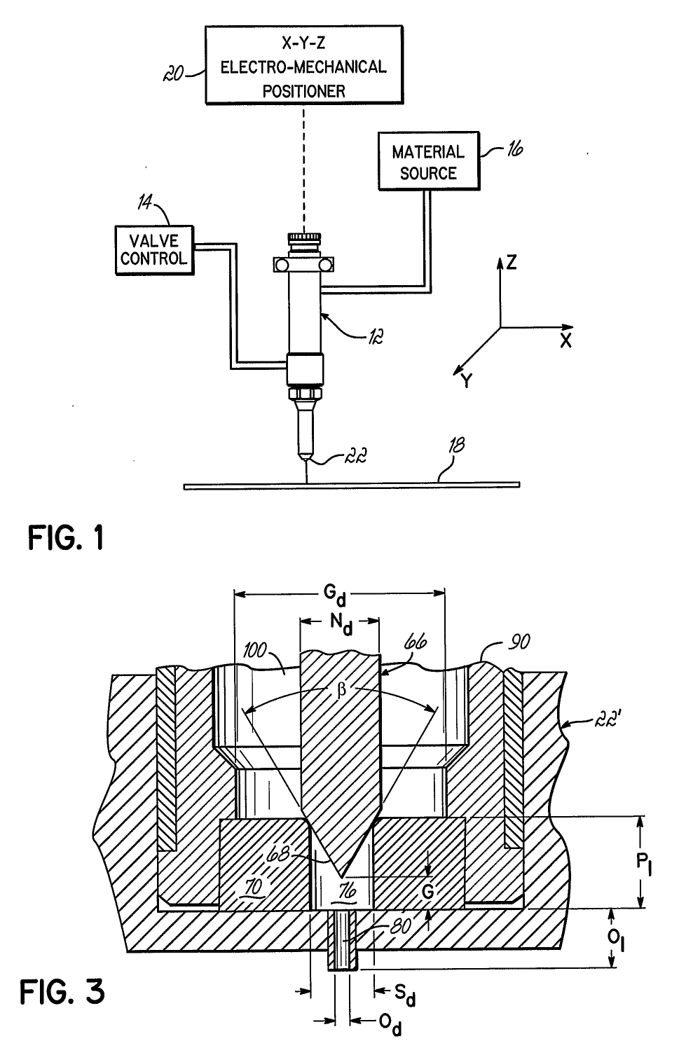

As shown in FIG. 1, a typical dispensing system 10 incorporating the present invention may comprise a valve 12 operated pneumatically or electrically for intermittent jetting of viscous liquids, such as solder paste, by a valve control 14 and receiving the viscous liquid from a material source 16.

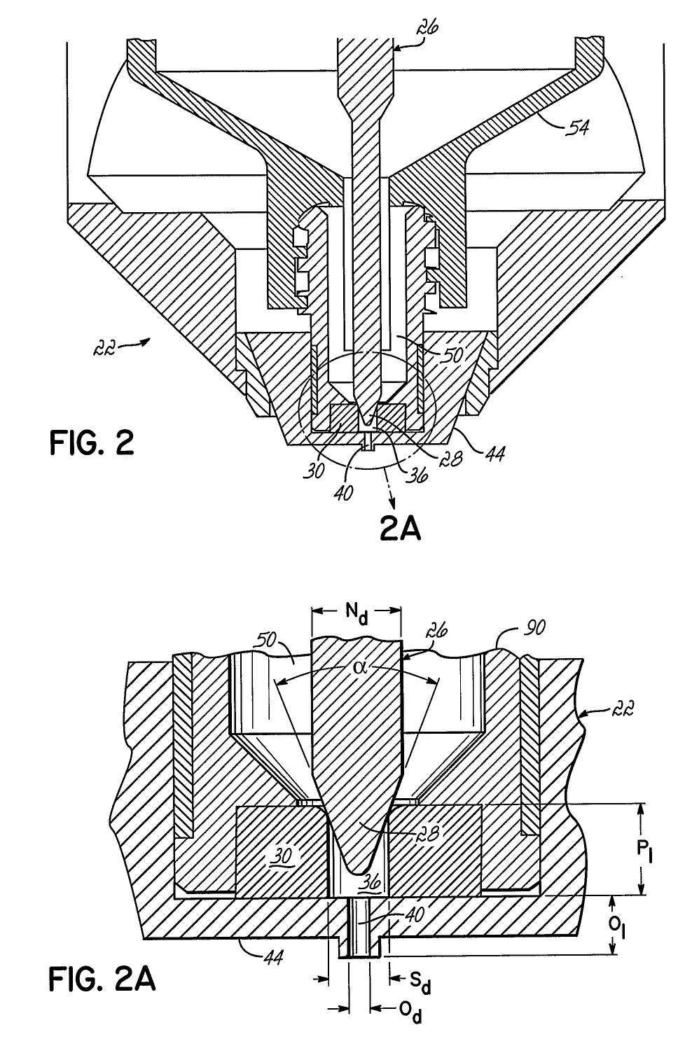

In a first embodiment, the valve 12 is positioned in x, y and z directions relative to a substrate 18 by a suitable positioner 20, such as a robot or other electro-mechanical positioner. The valve 12 may be conventional, except for the dispensing portion 22 as illustrated in greater detail in FIGS. 2 and 2A. In this regard, the valve 12 includes a reciprocating needle or valve stem 26 having a tapered end portion 28 that contacts a seat 30 to establish a closed position and moves away from the seat 30 into an open position (not shown). As will be described below, a jetting action of viscous material occurs as the needle 26 moves from the open to the closed position. The seat 30 includes a through passage 36 of circular cross section communicating with an outlet passage 40 of circular cross section in a nozzle portion 44 of the valve 12. It will be appreciated that valve 12 may be formed by a body or structure of various component parts.

As shown in FIG. 2A, the tapered end portion 28 of the needle 26 preferably is tapered at an included angle α of about 30° to about 40°. This angle α has been shown to help reduce the mechanical impact against solder paste material in the passage 36 and thereby lessen compacting of such material and resulting clogging of the passage 36. The total volume of the combined passages 36, 40 is, for example, 1.0 microliter, whereas the jetting volume of solder paste is 0.2 microliter. That is, the volume of material jetted upon each stroke of the valve element is about 20% of the total volume of the combined passages 36, 40. This percentage may be reduced further by reducing the inner diameter of the valve seat 30 (that is, the diameter of through passage 36) so that the chances of clogging may be reduced accordingly. Representative dimensions of the illustrative embodiment of dispensing portion 22 as shown in FIG. 2A are:

Needle Outer Diameter (N_{d})=1.5 mm

Seat Inner Diameter or Through Passage (36) Diameter (S_{d})=1.0 mm

Outlet Passage Diameter (O_{d})=0.34 mm

Outlet Passage Length (Oₗ)=1.0 mm

Through Passage Length (Pₗ)=1.5 mm

In use, a supply passage 50 is filled with a viscous material, such as solder paste, under pressure from, for example, a syringe 54. The viscous material may take on many different forms and may be used in many different applications. In the manufacture of printed circuit boards or other electronics products in which the inventive principles are especially suitable, for example, it is frequently necessary to apply minute amounts or droplets of liquid materials, including solder flux and solder paste, to a substrate or workpiece. These droplets can be on the order of 0.10 inch diameter and less. Such materials can generally have a viscosity greater than 25,000 centipoise and in the case of solder pastes, for example, may have a viscosity of 300,000 centipoise or above. These liquid and viscous materials, besides solder flux and solder paste, include adhesives, solder mask, grease, oil, encapsulants, potting compounds, inks, and silicones. When the valve stem 26 is raised from the closed position shown in FIGS. 2 and 2A and then quickly returned to the closed position, solder paste which has filled through passage 36 will be forcefully ejected from outlet passage 40 as a small (for example, 0.2 microliter) jet of material onto the substrate 18 (FIG. 1).

FIG. 3 illustrates an alternative embodiment of a dispensing portion 22′ which may be used on valve 10 (FIG. 1). In particular, a needle 66 is provided having a tapered end portion 68 that contacts a valve seat 70 in the same manner as described above during a jetting operation. The valve seat 70 includes a through passage 76 of circular cross section communicating with an outlet passage 80 of circular cross section in a nozzle portion 84. The tapered end portion 68 may be tapered at an included angle β of between about 30° and about 90°. In this embodiment, the needle or valve stem comes to a sharp point as compared to the first embodiment and, as also shown in the first embodiment, a gap G is formed between the tip of the needle 26 and the upstream end of the outlet passage 80. It has been found desirable, to prevent clogging of viscous material such as solder paste in the region of the nozzle and the through passage to establish an optimum relationship between the outer diameter N_{d} of the needle 66 relative to the inner diameter of the seat S_{d} (or, in other words, the diameter of the through passage 76). For example, the following examples for these dimensions are provided:

| N_{d} | S_{d} |
|---|---|
| 1.5 mm | 1.3 mm |
| 1.2 mm | 1.0 mm |
| 1.0 mm | 0.8 mm |
| 0.9 mm | 0.7 mm |
| 0.7 mm | 0.5 mm |

Thus, in each case, the inner diameter of the seat 70, or the diameter of the through passage 76, S_{d} is 0.2 mm less than the outer diameter N_{d} of the needle 66. Generally, S_{d} is between 10% and about 30% less than N_{d} The inner diameter G_{d} of the needle guide 90 should be 2 mm greater than the outer diameter N_{d} of the needle 66 at a location adjacent to valve seat 70. This helps to reduce the negative impact against the solder paste when the needle 66 impacts the valve seat 70. The distance or gap G between the tip of the needle 66 and the bottom of the valve seat 70 or through passage 76 should be less than about 5 mm to effectively jet or shoot the solder paste from the outlet passage 80. If the tip of the needle 66 is too close or near to the bottom of the valve seat 70 or through passage 76, the needle 66 may close the outlet passage 80 and hinder the jetting action. The other dimensions shown in FIG. 3 may be the same as those expressed above with respect to FIG. 2A. The use of dispensing portion 22′ in connection with valve 12 is as described above, with viscous material (not shown) being supplied to through passage 76 from a supply passage 100 in which needle or valve stem 66 at least partially resides.

While the present invention has been illustrated by a description of a preferred embodiment and while this embodiment has been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims.

What is claimed is:

1. A system for intermittent jetting of viscous materials, the system comprising:
a valve including a valve body having a supply passage, a valve stem mounted for reciprocating movement in said valve body between open and closed positions and having a tapered end, and a valve seat having a through passage communicating with an outlet passage of said valve body and with said supply passage when said valve stem is in the open position, the tapered end of said valve stem extending into said through passage in the closed position, and
a positioner device carrying said valve and capable of moving said valve in multiple directions relative to a substrate during a jetting operation,
wherein the amount of material jetted from said outlet passage during a stroke of said valve stem is less than about 25% of the total combined volumes of said through passage and said outlet passage.

2. The system of claim 1, wherein the end of said valve stem is tapered at an included angle less than about 40 degrees.

3. The system of claim 1, wherein the end of said valve stem is tapered at an included angle between about 30° and about 90°.

4. The system of claim 1, wherein said outlet passage and said through passage each have a diameter and the diameter of said outlet passage is smaller than the diameter of said through passage.

5. The system of claim 4, wherein the diameter of said outlet passage is approximately one third the diameter of said through passage.

6. The system of claim 1, wherein said outlet passage and said through passage each have a length and the length of said outlet passage is approximately two thirds of the length of said through passage.

7. The system of claim 1, wherein the end of said valve stem is tapered at an included angle between about 30 degrees and about 40 degrees.

8. A system for intermittent jetting of viscous materials, the system comprising:
a valve including a valve body having a supply passage, a valve stem mounted for reciprocating movement in said valve body between open and closed positions and having a tapered end, and a valve seat having a through passage communicating with an outlet passage of said valve body and with said supply passage when said valve stem is in the open position, the tapered end of said valve stem extending into said through passage in the closed position, and
a positioner device carrying said valve and capable of moving said valve in multiple directions relative to a substrate during a jetting operation,
wherein said outlet passage and said through passage each have a diameter and the diameter of said outlet passage is approximately one third the diameter of said through passage.

9. A system for intermittent jetting of viscous materials, the system comprising:
a valve including a valve body having a supply passage, a valve stem mounted for reciprocating movement in said valve body between open and closed positions and having a tapered end, and a valve seat having a through passage communicating with an outlet passage of said valve body and with said supply passage when said valve stem is in the open position, the end of said valve stem extending into said through passage in the closed position, and
a positioner device carrying said valve and capable of moving said valve in multiple directions relative to a substrate during a jetting operation,
wherein said outlet passage and said through passage each have a length and the length of said outlet passage is approximately two thirds of the length of said through passage.

10. The system of claim 9, wherein said outlet passage and said through passage each have a diameter and the diameter of said outlet passage is approximately one third the diameter of said through passage.

11. A system for intermittent jetting of viscous materials, the system comprising:
a valve including a valve body having a supply passage, a valve stem mounted for reciprocating movement in said valve body between open and closed positions and having a tapered end portion extending between a proximal end having a diameter N_{d} and a distal tip, and a valve seat having a through passage communicating with an outlet passage of said valve body and with said supply passage when said valve stem is in the open position, the end of said valve stem extending into said through passage in the closed position, and
a positioner device carrying said valve and capable of moving said valve in multiple directions relative to a substrate during a jetting operation,
wherein said through passage includes a diameter S_{d} and S_{d} is less than N_{d} by between approximately 10% and approximately 30%.

12. The system of claim 11, wherein N_{d} is equal to or less than approximately 1.5 mm.

13. The system of claim 12, wherein the difference between N_{d} and S_{d} is approximately 0.2.

14. A method for intermittently jetting viscous materials using a valve including a supply passage, a valve stem mounted for reciprocating movement between open and closed positions relative to a valve seat having a through passage, the valve stem having a tapered end, and a valve seat having a through passage communicating with an outlet passage of the valve body, the method comprising:
supplying the viscous material to the supply passage under pressure,
moving the valve stem to the open position such that the end of the valve stem moves from a position partially contained in the through passage to a position at least partially removed from the through passage,
filling the through passage with the viscous material,
moving the valve stem to the closed position such that the end of the valve stem moves from the open position to the closed position, and
jetting the viscous material from an outlet passage communicating with the through passage.

15. The method of claim 14, wherein the viscous material further comprises a solder paste.

16. The method of claim 15, wherein the solder paste is jetted onto an electronic component.

17. The method of claim 14, wherein the amount of material jetted from the outlet passage is less than about 25% of the total combined volumes of the through passage and the outlet passage.

18. The method of claim 14, further comprising:
carrying the valve on a positioner device,
moving the valve with the positioner device relative to a substrate, and
jetting the viscous material onto the substrate.

19. A valve for intermittent jetting of viscous materials, comprising:
a valve body having a supply passage,
a valve stem mounted for reciprocating movement in said valve body between open and closed positions and having a tapered end, and
a valve seat having a through passage communicating with an outlet passage of said valve body and with said supply passage when said valve stem is in the open position, the end of said valve stem extending into said through passage in the closed position, and
wherein the amount of material jetted from said outlet passage during a stroke of said valve stem is less than about 25% of the total combined volumes of said through passage and said outlet passage.

20. A valve for intermittent jetting of viscous materials, comprising:
a valve body having a supply passage,
a valve stem mounted for reciprocating movement in said valve body between open and closed positions and having a tapered end, and
a valve seat having a through passage communicating with an outlet passage of said valve body and with said supply passage when said valve stem is in the open position, the end of said valve stem extending into said through passage in the closed position,
wherein said outlet passage and said through passage each have a diameter and the diameter of said outlet passage is approximately one third the diameter of said through passage.

21. A valve for intermittent jetting of viscous materials, the system comprising:
a valve body having a supply passage,
a valve stem mounted for reciprocating movement in said valve body between open and closed positions and having a tapered end, and
a valve seat having a through passage communicating with an outlet passage of said valve body and with said supply passage when said valve stem is in the open position, the end of said valve stem extending into said through passage in the closed position,
wherein said outlet passage and said through passage each have a length and the length of said outlet passage is approximately two thirds of the length of said through passage.

22. The valve of claim 21, wherein said outlet passage and said through passage each have a diameter and the diameter of said outlet passage is approximately one third the diameter of said through passage.

23. A valve for intermittent jetting of viscous materials, comprising:
a valve body having a supply passage,
a valve stem mounted for reciprocating movement in said valve body between open and closed positions and having a tapered end portion extending between a widest portion having a diameter N_{d} and a distal tip, and
a valve seat having a through passage communicating with an outlet passage of said valve body and with said supply passage when said valve stem is in the open position, the end of said valve stem extending into said through passage in the closed position,
wherein said through passage includes a diameter S_{d} and S_{d} is less than N_{d} by between approximately 10% and approximately 30%.

24. The valve of claim 23, wherein N_{d} is equal to or less than approximately 1.5 mm.

25. The system of claim 24, wherein the difference between N_{d} and S_{d} is approximately 0.2 mm.
